(19) United States
(12) Patent Application Publication
(10) Pub. No.: US 2026/0339878 A1
(43) Pub. Date: Oct. 29, 2026

(54) METHOD FOR DECODING SERIAL PROTOCOL SIGNALS WITHOUT SYNC PATTERNS

(71) Applicant: Tektronix, Inc., Beaverton, OR (US)

(72) Inventors: Archana I. Akkalakot, Bengaluru (IN); Alka Kumari, Bengaluru (IN); Shifa Noorulain Mohammed Afzal, Bengaluru (IN)

(21) Appl. No.: 19/638,568

(22) Filed: Apr. 3, 2026

(30) Foreign Application Priority Data
Apr. 28, 2025 (IN) 202521041012

(51) Int. Cl. G06F 13/42; G06F 11/27

(52) U.S. Cl. CPC G06F 13/4282; G06F 11/27; G06F 2213/0042

(57) ABSTRACT

A test and measurement instrument is described that may identify, within the data during an acquisition interval, a bypassed control block. In addition, the test and measurement instrument may determine a state value of a linear feedback shift register (LFSR) based on the bypassed control block and a location of the bypassed control block within the acquisition interval. The test and measurement instrument may determine, based on the state value of the LFSR and the location of the bypassed control block, an LFSR state corresponding to an earlier position in the acquisition interval, by accounting for a relative positional relationship within the data. Moreover, the test and measurement instrument may descramble, using the LFSR state corresponding to the earlier position in the acquisition interval, at least a portion of the data to generate decoded data for data preceding the bypassed control block.

### CROSS-REFERENCE TO RELATED APPLICATIONS

This disclosure claims priority under 35 U.S.C. § 119 to Indian Provisional Patent Application No. 202521041012, titled “METHOD FOR DECODING SERIAL PROTOCOL SIGNALS WITHOUT SYNC PATTERNS,” filed on Apr. 28, 2025, the disclosure of which is incorporated herein by reference in its entirety.

### TECHNICAL FIELD

Examples of the present disclosure generally relate to high-speed serial communication systems and, in particular, to efficient data decoding and synchronization techniques for high-speed serial communication.

### BACKGROUND

High-speed serial protocols are communication protocols that transmit data over a serial interface at a high data rate. These protocols are commonly used in communication between electronic devices, such as computers, servers, and networking equipment.

The key advantages of these serial communication protocols are to provide reliable communication, low latency, and high bandwidth, making them ideal for high-performance computing applications. The different high-speed protocol standards in the market are Universal Standard Bus (USB), Peripheral Component Interconnect (PCI) Express, Serial Advanced Technology Attachment (SATA), High-Definition Multimedia Interface (HDMI), and Ethernet.

To increase the bandwidth to support higher data rates, the high-speed serial standards adopted different line encodings and data formats like 8b/10b, 64b/66b, 128b/130b, 128b/132b etc.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 shows a test and measurement instrument in a test set up using a probe to receive data from a device under test (DUT).

FIG. 2 shows different states of data transmission in Universal Serial Bus (USB) 3.2 Gen 2.

FIG. 3 shows the different states of data transmission in USB 3.2 Gen 2 using 23-bit scrambler on the transmitter side.

FIG. 4 illustrates a flow chart of a proposed solution for decoding the data from the beginning of the acquisition after SKP control block is detected according to an exemplary implementation of the present disclosure.

FIG. 5 and FIG. 6 illustrate a plot image of decoded data for idle pattern after applying the proposed solution, according to an exemplary implementation of the present disclosure.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

The present disclosure relates to advanced methods and systems for decoding and synchronizing high-speed serial protocol data streams, particularly in situations where traditional synchronization patterns may be absent or compromised. As modern serial communication protocols continue to increase in speed and complexity, maintaining reliable synchronization between transmitter and receiver is both critical and challenging. To address these challenges, the disclosed techniques provide mechanisms for robust and flexible decoding of serial data without exclusive reliance on conventional sync patterns. The invention supports improved system reliability and a broader range of applications by enabling accurate data recovery even when explicit synchronization cues are unavailable. The following detailed description, supported by illustrative figures and exemplary implementations, outlines the structures, processes, and advantages associated with the proposed solution, emphasizing its applicability to high-speed protocols such as USB and PCIe.

The embodiments herein involve a test and measurement instrument and method to descramble, and decode, Universal Serial Bus (USB) 3.2 Gen 2 waveforms after the standard-defined link initialization and training process. The embodiments accomplish decoding and synchronizing high-speed serial protocol data streams. The below discussion focuses on USB 3.2 Gen2, but the embodiments described herein may apply to future USB standards or other serial data communication protocols. The discussion will therefore refer to the standard as USB 3.2 gen 2 and later USB versions as “USB 3.X.”

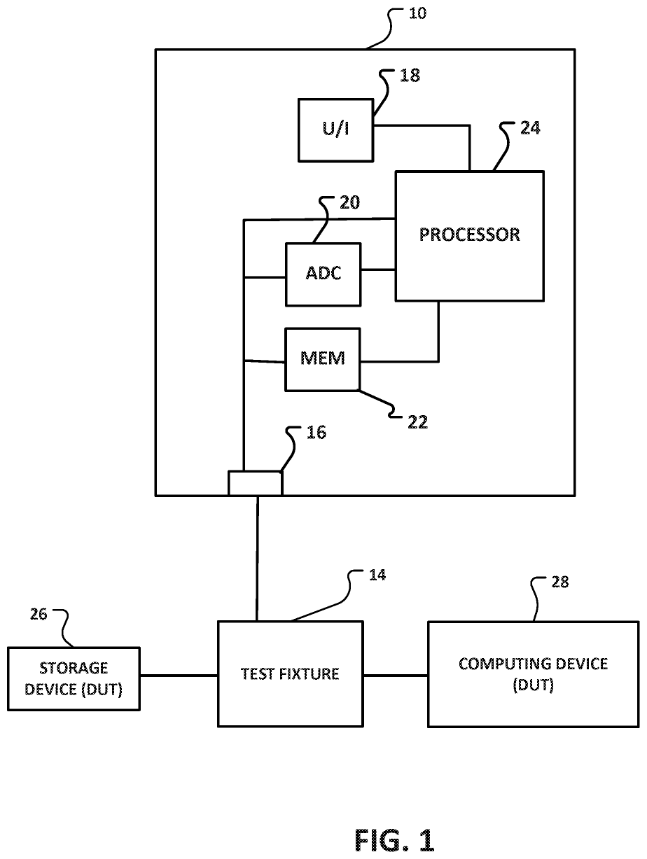

FIG. 1 shows an example situation in which the USB communications may need to undergo descrambling, which the discussion may also refer to as decoding. The test and measurement instrument 10 connects to a text fixture 14 that is in turn connected to a computing device 28 and a storage device 26. The connection may involve one or more probes on the test fixture. While these will both be referred as DUTs, the descrambling operation applies to whichever of the computing device 28 or the storage device 26 is transmitting the data. The test fixture 14 sends the USB data through one or more channels 16 on test and measurement instrument 10. In some embodiments, the test fixture 14 may comprise a probe. As discussed above, the embodiments herein will typically only use one probe and one channel of the test and measurement instrument 10, but more may be used.

The data from the test fixture 14, if analog, undergoes conversion to digital by one or more analog-to-digital converters (ADC), such as ADC 20. The ADC 20 converts the analog data to digital data for the one or more processors such as processor 24 to operate upon the digital data. If the data received comprises digital data, the digital data may not need to pass through the ADC 20. The test and measurement instrument 10 may include a memory 22 to allow the one or more processors 24 to store the digital and analog data and may contain the code to be executed by the one or more processors 24. User interface 18 allows the test and measurement instrument 10 to display at least the resulting current measurement to the user, and may include controls such as buttons, knobs, sliders, trackballs, etc., to allow the user to perform operations on the incoming signals, etc.

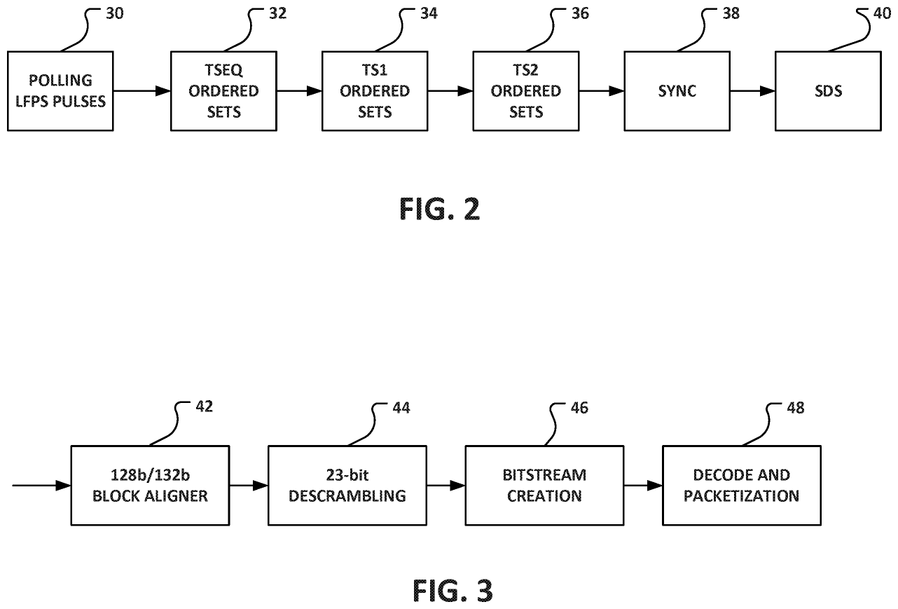

Currently, the USB 3.2 Gen2 standard performs a link initialization and training mode to negotiate and establish the link. For link Initialization and training mode different training sequences are sent on the bus to negotiate/establish the link. In FIG. 2 at 30, the sequences start with low frequency pulse stimulation (LFPS). The training sequences TSEQ 32, TS1 34, and TS2 36, occur to train the link between the USB device 26 and the computing device 28 to which the USB device is connected, as shown in FIG. 1. After the training sequences, the SYNC signal at 38 indicates data transmission (SDS) at 40.

Issues arise with the baseband signals because, while the training sequences involve sending continuous 1's or 0's, the electromagnetic induction (EMI) and peak emissions across the connections lines can lead to errors. Hence data scrambling is used to reduce EMI (Electro Magnetic Induction) or peak emissions.

Data scrambling in USB 3.2 Gen 2 uses a 23-bit scrambler on the transmitter side to overcome EMI which is encoded using 128b/132b, before the final data has been sent to devices on the receiver side. The discussion here uses the term “descrambling” and “decoding” interchangeably, meaning the process to convert the scrambled data to unscrambled data recognizable by the receiver.

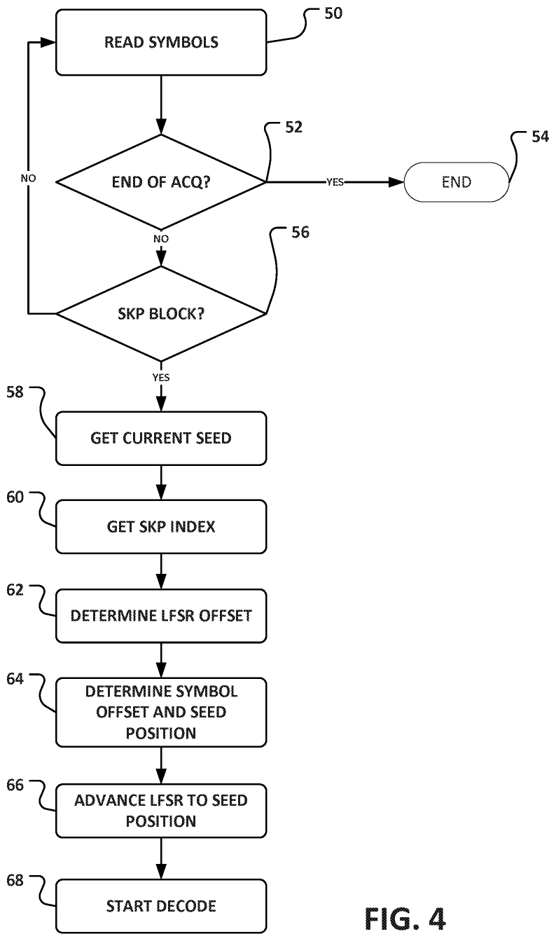

FIG. 3 shows a block diagram depicting different steps used to decode USB 3.2 Gen2 signal. The first step of signal decoding occurs at 42 in which the Gen2 signal operates at 10 Gbps (Giga bits per second), the received data contains 132 bits in which 4-bit block identifier is either control (1100) or data (0011) blocks prepended to be 16 symbols (128 bits) to create 128b/132b line encoding.

At 44, descrambler uses 23-bit polynomial for data descrambling. The polynomial can be expressed as:

X²³+X²¹+X¹⁶+X⁸+X⁵+X²+1

The descrambler logic uses the Linear Feedback Shift Register (LFSR) mentioned above, which is a 23-bit register. The initial state of the LFSR is 0x1dbfbc. There are certain rules that 3.2 Gen2 communications follow for descrambling and creation of the bitstream at 46 that is then decoded and packetized at 48.

For high-speed protocols some of the ordered sets like TS1, TS2 (1-13 symbols), data block containing 16 symbols each are scrambled and rest of the blocks like SKP, SYNC, FTS, SDS, EIEOS etc. are bypassed.

Achieving high-speed decoding requires establishing synchronization, which means getting the scrambler key and using the scrambler key to extract data from the encrypted data and then decoding the extracted data. The decode for encrypted data cannot start till the scrambler key is extracted from the incoming signal. To extract the scrambler key, the high-speed protocols define the SYNC pattern after the training sequence. The SKP order set is sent after every forty (40) blocks during communication for clock compensation, data alignment (by sending LFSR state along) and to prevent errors. The LFSR state can be used to reacquire block alignment in the midst of a bit stream.

Since trace tools cannot force the link to enter recovery, as tools can reacquire bit lock, if needed, and monitor for the SKP ordered set to obtain block alignment and perform lane-to-lane de-skew. The LFSR value from the SKP 5 ordered set can be loaded into its LFSR to start interpreting the bit stream. It must be noted that with a bit stream one may alias to a SKP ordered set on a non-block boundary. The trace tools can validate their block alignment by using implementation specific means such as receiving a fixed number of valid packets or sync headers or subsequent SKP ordered sets as shown below in TABLE 1.

TABLE 1

| Symbol Number | Value | Description |
|---|---|---|
| 0 through (4*N − 1) | AAh | SKP symbol. Symbol 0 is the SKP |
| [N can be 1 through 5] | | ordered set identifier |
| 4*N | E1h | SKP_END symbol. Signifies the end |
| | | of the SKP ordered set after three |
| | | more symbols |
| 4*N + 1 | 00-FFh | (i) if LTSSM state is polling. |
| | | Compliance: Aah |
| | | (ii) Else if prior block was a data block: |
| | | bit[7] = data parity |
| | | bit[6:0] = LFSR[22:16] |
| | | (iii) Else: |
| | | bit[7] = ~LFSR[22] |
| | | bit[6:0] = ~LFSR[[22:16] |
| 4*N + 2 | | (i) if LTSSM state is polling. |
| | | Compliance: Error_Status[7:0] |
| | | (ii) Else: LFSR[15:8] |
| 4*N + 3 | | (i) if LTSSM state is polling. |
| | | Compliance: Error_Status[7:0] |
| | | (ii) Else: LFSR[7:0] |

However, specific challenges are encountered with Linear Feedback Shift Register (LFSR) synchronization in SKP ordered sets due to the need for precise alignment and initialization to ensure correct data decoding. As mentioned previously The SKP symbols are used to reacquire block alignment in the midst of bitstream. To decode the acquired data, there is a need to do synchronization. In high-speed protocols like USB, PCIe the below mechanisms can be used to do the synchronization.

One synchronization mechanism involves SYNC Symbols and EIEOS Symbols. Here the LFSR gets initialized to its initial value. The decode uses this LFSR value to start the data decoding.

Another synchronization mechanism involves SKP symbols used to get the seed value whose last 3 symbols contain LFSR state. This LFSR state can be used to start the decode. For example, in USB 3.2 Gen 2, training sequences, like TS1 and TS2, contain scrambled symbols. Decoding these scrambled symbols involves searching for SKP symbols. Once the SKP symbols are received, the LFSR key is read.

However, the decode starts only after syncing with SKP. Before syncing whatever data is there, it cannot be decoded.

The present disclosure provides a solution that decodes the data from the beginning of the acquisition after SKP control block is detected.

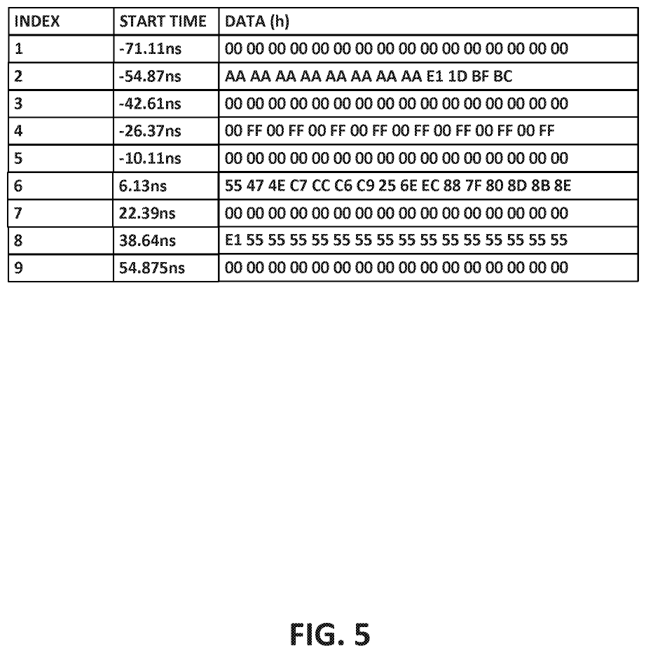

FIG. 4 shows an embodiment of a method for decoding the data from the beginning of the acquisition after SKP control block is detected. The method is typically implemented by one or more processors in the test and measurement instrument configured to execute code embodying the method. The embodiment starts with reception of data from the DUT at 50. In some embodiments, receiving the data from the DUT involves reading symbols. The process looks to determine whether there are more symbols and/or data to acquire from the DUT at 52. If it is the end of acquisition, then the process ends at 54.

However, if there is more data to read from the DUT, then at 56, the process determines whether the symbol read from the DUT is a SKP block. If the read symbol is not a SKP block, then the process goes back to 50 to continue reading symbols from the DUT. At this point in the process, the test and measurement instrument is searching for the control header followed by SKP block whose size is 4*N+3 (where N can be 1 to 5).

If the read symbol is a SKP block, the process continues to 58 where the process gets the current seed. In some embodiments, the current seed can be determined by reading the last three symbols of the SKP block, which is the LFSR value.

Furthermore, the process gets the index of the SKP block (SKPIndex) at 60. The index of the SKP block involves getting the bit index of the start of the SKP block, once the SKP is found.

In some examples, getting the current seed and getting the SKP index can be interchanged, such that getting the current seed and getting the SKP index can be performed in any order.

The process then includes determining the LFSR offset based on the SKP index and the current index at 62. Determining the LFSR offset can involve calculating the LFSR offset to know the change the LFSR value from the initial LFSR value (i.e., LFSR initial value: 0x1dbfbc). Based on the indexing of SKP and current index of the acquisition from the beginning the process involves calculating the LFSR state using the change in the LFSR value from the initial LFSR value (LFSR initial value: 0x1dbfbc).

The process then includes determining the symbol offset at 64. The symbol offset is the total number of symbols before the SKP block (based on the index of the SKP block). In some examples, the symbol offset can be based on the following equation: SymbolOffset=(SKPIndex−CurrentIndex)/8.

The process includes determining the seed position based on the LFSR offset and the symbol offset at 64. In some examples, getting the seed value at the beginning of the acquisition involves the following equation: SeedPos=Offset−SymbolOffset.

Once the seed position is determined, the process involves advancing the LFSR from the initial value to the seed position at 66. Doing so gives the LFSR value at the beginning of the acquisition. Advancing the LFSR can involve shifting/rotating the LFSR the known LFSR value a number of times based on the difference between the seed position and the initial LFSR value.

Once LFSR is locked, the process can start data decoding at 68.

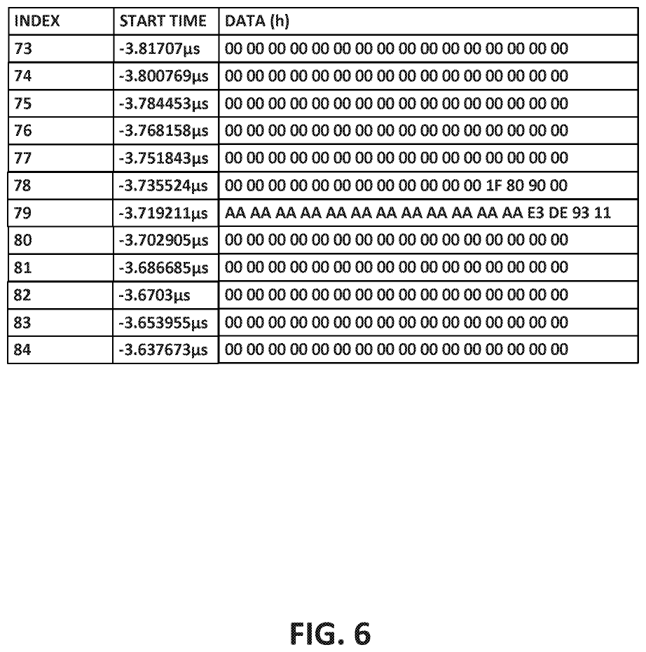

FIG. 5 and FIG. 6 illustrate the image of decoded data of the entire acquisition in tabular format after applying the above proposed solution.

The advantage of the solution of the present disclosure is in the performance of the decode solution so that it should not miss any bits in the acquisition. This approach is fast enough to get the decode done as it uses last three SKP symbols and then calculates the seed value.

This also decodes the acquired data before SKP symbol. As per competitive analysis, the decoders are not decoding before SKP symbol. There is no need for additional probing of the side band signal as the existing signal is used to extract the seed. The present solution does not need additional channels for side band signal, decode of the side band data, etc. The performance of the decode is improved as the proposed solution is not relying on the scrambled incoming symbol data for seed extraction. The solution is using a non-scrambled SKP symbol.

According to the present disclosure, the uniqueness of the present solution lies in decoding the data from the beginning of Acquisition using SKP.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a test and measurement instrument, may include: one or more channels to receive data from a device under test (DUT) through a test fixture, the data being transmitted by the DUT in accordance with a serial data communication protocol; and one or more processors configured to execute code that causes the one or more processors to: identify, within the data during an acquisition interval, a bypassed control block; determine a state value of a linear feedback shift register (LFSR) based on the bypassed control block and a location of the bypassed control block within the acquisition interval; determine, based on the state value of the LFSR and the location of the bypassed control block, an LFSR state corresponding to an earlier position in the acquisition interval, by accounting for a relative positional relationship within the data; and descramble, using the LFSR state corresponding to the earlier position in the acquisition interval, at least a portion of the data to generate decoded data for data preceding the bypassed control block.

Example 2 is the test and measurement instrument of Example 1, where the serial data communication protocol may include a Universal Serial Bus (USB) protocol 3_prd_x_prd_

Example 3 is the test and measurement instrument of Example 1 or Example 2, where the bypassed control block may include a SKP control block.

Example 4 is the test and measurement instrument of any one of Example 1-3, where determining the state value of the LFSR may include extracting the LFSR state from a subset of symbols within the bypassed control block.

Example 5 is the test and measurement instrument of any one of Example 1-4, where the subset of symbols may include a plurality of symbols of the bypassed control block that encode the LFSR state.

Example 6 is the test and measurement instrument of any one of Example 1-5, where the location of the bypassed control block within the acquisition interval is determined using a symbol index or a bit index.

Example 7 is the test and measurement instrument of any one of Example 1-6, where accounting for the relative positional relationship may include determining an offset between the location of the bypassed control block and a beginning of the acquisition interval.

Example 8 is the test and measurement instrument of any one of Example 1-7, where the offset is based on a number of symbols preceding the bypassed control block within the acquisition interval.

Example 9 is the test and measurement instrument of any one of Example 1-8, where determining the LFSR state corresponding to the beginning of the acquisition interval may include advancing or reversing the LFSR based on the offset.

Example 10 is the test and measurement instrument of any one of Example 1-9, where the LFSR has an initial state value specified by the serial data communication protocol.

Example 11 is a method of synchronizing serial communication data, may include: receiving the serial communication data from a device under test (DUT); identifying, within the data during an acquisition interval, a bypassed control block; determining a state value of a linear feedback shift register (LFSR) based on the bypassed control block and a location of the bypassed control block within the acquisition interval; determining, based on the state value of the LFSR and the location of the bypassed control block, an LFSR state corresponding to an earlier position in the acquisition interval, by accounting for a relative positional relationship within the data; and descrambling, using the LFSR state corresponding to the earlier position in the acquisition interval, at least a portion of the data to generate decoded data for data preceding the bypassed control block.

Example 12 is the method of Example 11, where receiving the serial communication data is accordance with a Universal Serial Bus (USB) protocol 3_prd_x_prd_

Example 13 is the method of Example 11 or Example 12, where the bypassed control block may include a SKP control block.

Example 14 is the method of any one of Example 11-13, where determining the state value of the LFSR may include extracting the LFSR state from a subset of symbols within the bypassed control block.

Example 15 is the method of any one of Example 11-14, where the subset of symbols may include a plurality of symbols of the bypassed control block that encode the LFSR state.

Example 16 is the method of any one of Example 11-15, where the location of the bypassed control block within the acquisition interval is determined using a symbol index or a bit index.

Example 17 is the method of any one of Example 11-16, where accounting for the relative positional relationship may include determining an offset between the location of the bypassed control block and a beginning of the acquisition interval.

Example 18 is the method of any one of Example 11-17, where the offset is based on a number of symbols preceding the bypassed control block within the acquisition interval.

Example 19 is the method of any one of Example 11-18, where determining the LFSR state corresponding to the beginning of the acquisition interval may include advancing or reversing the LFSR based on the offset.

Example 20 is the method of any one of Example 11-19, where the LFSR has an initial state value specified by the serial data communication protocol.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific examples of the invention have been illustrated and described for purposes of illustration, it will be understood that various modifications may be made without departing from the spirit and scope of the invention. Accordingly, the invention should not be limited except as by the appended claims.

What is claimed is:

1. A test and measurement instrument, comprising:
one or more channels to receive data from a device under test (DUT) through a test fixture, the data being transmitted by the DUT in accordance with a serial data communication protocol; and
one or more processors configured to execute code that causes the one or more processors to:
identify, within the data during an acquisition interval, a bypassed control block;
determine a state value of a linear feedback shift register (LFSR) based on the bypassed control block and a location of the bypassed control block within the acquisition interval;
determine, based on the state value of the LFSR and the location of the bypassed control block, an LFSR state corresponding to an earlier position in the acquisition interval, by accounting for a relative positional relationship within the data; and
descramble, using the LFSR state corresponding to the earlier position in the acquisition interval, at least a portion of the data to generate decoded data for data preceding the bypassed control block.

2. The test and measurement instrument of claim 1, wherein the serial data communication protocol comprises a Universal Serial Bus (USB) protocol 3.x.

3. The test and measurement instrument of claim 1, wherein the bypassed control block comprises a SKP control block.

4. The test and measurement instrument of claim 1, wherein determining the state value of the LFSR comprises extracting the LFSR state from a subset of symbols within the bypassed control block.

5. The test and measurement instrument of claim 4, wherein the subset of symbols comprises a plurality of symbols of the bypassed control block that encode the LFSR state.

6. The test and measurement instrument of claim 1, wherein the location of the bypassed control block within the acquisition interval is determined using a symbol index or a bit index.

7. The test and measurement instrument of claim 1, wherein accounting for the relative positional relationship comprises determining an offset between the location of the bypassed control block and a beginning of the acquisition interval.

8. The test and measurement instrument of claim 7, wherein the offset is based on a number of symbols preceding the bypassed control block within the acquisition interval.

9. The test and measurement instrument of claim 7, wherein determining the LFSR state corresponding to the beginning of the acquisition interval comprises advancing or reversing the LFSR based on the offset.

10. The test and measurement instrument of claim 1, wherein the LFSR has an initial state value specified by the serial data communication protocol.

11. A method of synchronizing serial communication data, comprising:
receiving the serial communication data from a device under test (DUT);
identifying, within the data during an acquisition interval, a bypassed control block;
determining a state value of a linear feedback shift register (LFSR) based on the bypassed control block and a location of the bypassed control block within the acquisition interval;
determining, based on the state value of the LFSR and the location of the bypassed control block, an LFSR state corresponding to an earlier position in the acquisition interval, by accounting for a relative positional relationship within the data; and
descrambling, using the LFSR state corresponding to the earlier position in the acquisition interval, at least a portion of the data to generate decoded data for data preceding the bypassed control block.

12. The method of claim 11, wherein receiving the serial communication data is accordance with a Universal Serial Bus (USB) protocol 3.x.

13. The method of claim 11, wherein the bypassed control block comprises a SKP control block.

14. The method of claim 11, wherein determining the state value of the LFSR comprises extracting the LFSR state from a subset of symbols within the bypassed control block.

15. The method of claim 14, wherein the subset of symbols comprises a plurality of symbols of the bypassed control block that encode the LFSR state.

16. The method of claim 11, wherein the location of the bypassed control block within the acquisition interval is determined using a symbol index or a bit index.

17. The method of claim 11, wherein accounting for the relative positional relationship comprises determining an offset between the location of the bypassed control block and a beginning of the acquisition interval.

18. The method of claim 17, wherein the offset is based on a number of symbols preceding the bypassed control block within the acquisition interval.

19. The method of claim 17, wherein determining the LFSR state corresponding to the beginning of the acquisition interval comprises advancing or reversing the LFSR based on the offset.

20. The method of claim 11, wherein the LFSR has an initial state value specified by a serial data communication protocol.
